(19) United States
(12) Patent Application Publication
(10) Pub. No.: US 2026/0065869 A1
(43) Pub. Date: Mar. 5, 2026

(54) ELECTROPHORETIC DISPLAYS WITH EXPANDED COLOR PALETTES

(71) Applicant: E Ink Corporation, Billerica, MA (US)

(72) Inventors: Duc-Cuong DAO, San Jose, CA (US); Crystal NGUYEN, Bedford, MA (US); George G. HARRIS, Woburn, MA (US); Bryan Hans CHAN, San Francisco, CA (US)

(21) Appl. No.: 19/296,417

(22) Filed: Aug. 11, 2025

Related U.S. Application Data
(60) Provisional application No. 63/688,468, filed on Aug. 29, 2024.

(51) Int. Cl. G09G 3/34; G02F 1/167; G02F 1/1685

(52) U.S. Cl. CPC G09G 3/344; G02F 1/167; G02F 1/1685; G09G 2310/068; G09G 2320/0666

(57) ABSTRACT

A method for driving a color electrophoretic display includes (a) receiving an image to be displayed; and (b) driving each display pixel of the electrophoretic display to a targeted color state by applying time-dependent voltages of waveforms between the pixel electrodes and the light-transmissive electrode of the display to render the image. To produce a primary color at a display pixel, a primary color waveform corresponding to the primary color is selected from the set of primary color waveforms and applied to the display pixel. To produce a variation of a primary color at a display pixel, a scaling factor corresponding to the variation is selected from the set of scaling factors and applied to the corresponding primary color waveform to generate a scaled waveform, and the scaled waveform is applied to the display pixel.

### CROSS REFERENCE TO RELATED APPLICATION(S)

This application claims priority from U.S. Provisional Ser. No. 63/688,468 filed on Aug. 29, 2024 entitled ELECTROPHORETIC DISPLAYS WITH EXPANDED COLOR PALETTES, which is hereby incorporated by reference in its entirety.

### BACKGROUND

The present application relates generally to electrophoretic displays and, more particularly, to methods for expanding the color palettes of such displays.

Electrophoretic displays change color by modifying the position of a charged colored particle with respect to a light-transmissive viewing surface. Such electrophoretic displays are typically referred to as “electronic paper” or “ePaper” because the resulting display has high contrast and is sunlight-readable, much like ink on paper. Electrophoretic displays have enjoyed widespread adoption in eReaders, such as the AMAZON KINDLE® because the electrophoretic displays provide a book-like reading experience, use little power, and allow a user to carry a library of hundreds of books in a lightweight handheld device.

For many years, electrophoretic displays included only two types of charged color particles, black and white. (To be sure, “color” as used herein includes black and white.) The white particles are often of the light scattering type, and comprise, e.g., titanium dioxide, while the black particle are absorptive across the visible spectrum, and may comprise carbon black, or an absorptive metal oxide, such as copper chromite. In the simplest sense, a black and white electrophoretic display only requires a light-transmissive electrode at the viewing surface, a back electrode, and an electrophoretic medium including oppositely charged white and black particles. When a voltage of one polarity is provided, the white particles move to the viewing surface, and when a voltage of the opposite polarity is provided the black particles move to the viewing surface. If the back electrode includes controllable regions (pixels)—either segmented electrodes or an active matrix of pixel electrodes controlled by transistors—a pattern can be made to appear electronically at the viewing surface. The pattern can be, e.g., the text to a book.

More recently, a variety of color option have become commercially available for electrophoretic displays, including three-color displays (black, white, red; black white, yellow), and four color displays (black, white, red, yellow). Similar to the operation of black and white electrophoretic displays, electrophoretic displays with three or four reflective pigments operate similar to the simple black and white displays because the desired color particle is driven to the viewing surface. The driving schemes are far more complicated than only black and white, but in the end, the optical function of the particles is the same.

Advanced Color electronic Paper (ACeP®) also includes four particles, but the cyan, yellow, and magenta particles are subtractive rather than reflective, thereby allowing thousands of colors to be produced at each pixel. The color process is functionally equivalent to the printing methods that have long been used in offset printing and ink-jet printers. A given color is produced by using the correct ratio of cyan, yellow, and magenta on a bright white paper background. In the instance of ACeP®, the relative positions of the cyan, yellow, magenta and white particles with respect to the viewing surface will determine the color at each pixel. While this type of electrophoretic display allows for thousands of colors at each pixel, it is critical to carefully control the position of each of the (50 to 500 nanometer-sized) pigments within a working space of about 10 to 20 micrometers in thickness. Obviously, variations in the position of the pigments will result in incorrect colors being displayed at a given pixel. Accordingly, exquisite voltage control is required for such a system. More details of this system are available in the following U.S. Patents, all of which are incorporated by reference in their entireties: U.S. Pat. Nos. 9,361,836, 9,921,451, 10,276,109, 10,353,266, 10,467,984, and 10,593,272.

This application relates to color electrophoretic displays capable of rendering more than two colors using a single layer of electrophoretic material comprising a plurality of colored particles, e.g., white, cyan, yellow, and magenta particles. In some instances, two of the particles will be positively-charged, and two particles will be negatively-charged. In some instances, three of the particles will be positively-charged, and one particle will be negatively-charged. In some instances, one positively-charged particle will have a thick polymer shell and one negatively-charged particle has a thick polymer shell.

The term gray state is used herein in its conventional meaning in the imaging art to refer to a state intermediate two extreme optical states of a pixel, and does not necessarily imply a black-white transition between these two extreme states. For example, several of the E Ink patents and published applications referred to below describe electrophoretic displays in which the extreme states are white and deep blue, so that an intermediate gray state would actually be pale blue. Indeed, as already mentioned, the change in optical state may not be a color change at all. The terms black and white may be used hereinafter to refer to the two extreme optical states of a display, and should be understood as normally including extreme optical states that are not strictly black and white, e.g., the aforementioned white and dark blue states.

The terms bistable and bistability are used herein in their conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times, e.g., at least four times, the minimum duration of the addressing pulse required to change the state of the display element. It is shown in U.S. Pat. No. 7,170,670 that some particle-based electrophoretic displays capable of gray scale are stable not only in their extreme black and white states but also in their intermediate gray states, and the same is true of some other types of electro-optic displays. This type of display is properly called multi-stable rather than bistable, although for convenience the term bistable may be used herein to cover both bistable and multi-stable displays.

The term impulse, when used to refer to driving an electrophoretic display, is used herein to refer to the integral of the applied voltage with respect to time during the period in which the display is driven.

A particle that absorbs, scatters, or reflects light, either in a broad band or at selected wavelengths, is referred to herein as a colored or pigment particle. Various materials other than pigments (in the strict sense of that term as meaning insoluble colored materials) that absorb or reflect light, such as dyes or photonic crystals, etc., may also be used in the electrophoretic media and displays.

Particle-based electrophoretic displays have been the subject of intense research and development for a number of years. In such displays, a plurality of charged particles (sometimes referred to as pigment particles) move through a fluid under the influence of an electric field. Electrophoretic displays can have attributes of good brightness and contrast, wide viewing angles, state bistability, and low power consumption when compared with liquid crystal displays. Nevertheless, problems with the long-term image quality of these displays have prevented their widespread usage. For example, particles that make up electrophoretic displays tend to settle, resulting in inadequate service-life for these displays.

As noted above, electrophoretic media require the presence of a fluid. In most prior art electrophoretic media, this fluid is a liquid, but electrophoretic media can be produced using gaseous fluids; see, e.g., Kitamura, T., et al., Electrical toner movement for electronic paper-like display, IDW Japan, 2001, Paper HCS1-1, and Yamaguchi, Y., et al., Toner display using insulative particles charged triboelectrically, IDW Japan, 2001, Paper AMD4-4). See also U.S. Pat. Nos. 7,321,459 and 7,236,291. Such gas-based electrophoretic media appear to be susceptible to the same types of problems due to particle settling as liquid-based electrophoretic media, when the media are used in an orientation which permits such settling, e.g., in a sign where the medium is disposed in a vertical plane. Indeed, particle settling appears to be a more serious problem in gas-based electrophoretic media than in liquid-based ones, since the lower viscosity of gaseous suspending fluids as compared with liquid ones allows more rapid settling of the electrophoretic particles.

Numerous patents and applications assigned to or in the names of the Massachusetts Institute of Technology (MIT) and E Ink Corporation describe various technologies used in encapsulated electrophoretic and other electro-optic media. Such encapsulated media comprise numerous small capsules, each of which itself comprises an internal phase containing electrophoretically-mobile particles in a fluid medium, and a capsule wall surrounding the internal phase. Typically, the capsules are themselves held within a polymeric binder to form a coherent layer positioned between two electrodes. The technologies described in these patents and applications include:
(a) Electrophoretic particles, fluids and fluid additives; see, e.g., U.S. Pat. No. 7,002,728;
(b) Capsules, binders and encapsulation processes; see, e.g., U.S. Pat. Nos. 6,922,276 and 7,411,719;
(c) Microcell structures, wall materials, and methods of forming microcells; see, e.g., U.S. Pat. Nos. 7,072,095 and 9,279,906;
(d) Methods for filling and sealing microcells; see, e.g., U.S. Pat. No. 7,715,088 and U.S. Patent Application Publication No. 2002/0188053;
(e) Films and sub-assemblies containing electro-optic materials; see, e.g., U.S. Pat. Nos. 6,982,178 and 7,839,564;
(f) Backplanes, adhesive layers and other auxiliary layers and methods used in displays; see, e.g., U.S. Pat. Nos. 7,116,318 and 7,535,624;
(g) Color formation and color adjustment; see, e.g., U.S. Pat. Nos. 7,075,502 and 7,839,564;
(h) Methods for driving displays; see, e.g., U.S. Pat. Nos. 7,012,600 and 7,453,445;
(i) Applications of displays; see, e.g., U.S. Pat. Nos. 7,312,784 and 8,009,348; and
(j) Non-electrophoretic displays, as described in U.S. Pat. No. 6,241,921 and U.S. Patent Applications Publication No. 2015/0277160; and applications of encapsulation and microcell technology other than displays; see, e.g., U.S. Patent Application Publications Nos. 2015/0005720 and 2016/0012710.

Many of the aforementioned patents and applications recognize that the walls surrounding the discrete microcapsules in an encapsulated electrophoretic medium could be replaced by a continuous phase, thus producing a so-called polymer-dispersed electrophoretic display, in which the electrophoretic medium comprises a plurality of discrete droplets of an electrophoretic fluid and a continuous phase of a polymeric material, and that the discrete droplets of electrophoretic fluid within such a polymer-dispersed electrophoretic display may be regarded as capsules or microcapsules even though no discrete capsule membrane is associated with each individual droplet; see for example, U.S. Pat. No. 6,866,760. Accordingly, for purposes of the present application, such polymer-dispersed electrophoretic media are regarded as sub-species of encapsulated electrophoretic media.

A related type of electrophoretic display is a so-called microcell electrophoretic display. In a microcell electrophoretic display, the charged particles and the fluid are not encapsulated within microcapsules but instead are retained within a plurality of cavities formed within a carrier medium, typically a polymeric film. See, e.g., U.S. Patents Nos. 6,672,921 and 6,788,449.

Although electrophoretic media are often opaque (since, e.g., in many electrophoretic media, the particles substantially block transmission of visible light through the display) and operate in a reflective mode, many electrophoretic displays can be made to operate in a so-called shutter mode in which one display state is substantially opaque and one is light-transmissive. See, e.g., U.S. Pat. Nos. 5,872,552; 6,130,774; 6,144,361; 6,172,798; 6,271,823; 6,225,971; and 6,184,856. Dielectrophoretic displays, which are similar to electrophoretic displays but rely upon variations in electric field strength, can operate in a similar mode; see U.S. Pat. No. 4,418,346. Other types of electro-optic displays may also be capable of operating in shutter mode. Electro-optic media operating in shutter mode can be used in multi-layer structures for full color displays; in such structures, at least one layer adjacent the viewing surface of the display operates in shutter mode to expose or conceal a second layer more distant from the viewing surface.

An encapsulated electrophoretic display typically does not suffer from the clustering and settling failure mode of traditional electrophoretic devices and provides further advantages, such as the ability to print or coat the display on a wide variety of flexible and rigid substrates. (Use of the word printing is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; electrophoretic deposition (See U.S. Patent No. 7,339,715); and other similar techniques.) Thus, the resulting display can be flexible. Further, because the display medium can be printed (using a variety of methods), the display itself can be made inexpensively.

A commonly used system for quantifying the color characteristics of a display, including both brightness and hue is the CIELAB system, which assigns color coordinate values (i.e., L*, a*, b*) corresponding to colors displayed by typical color reflective display devices under a CIE standard illuminant D65 (e.g., with color temperature 6500K). L* represents lightness from black to white on a scale of zero to 100, while a* and b* represent chromaticity with no specific numeric limits. Negative a* corresponds with green, positive a* corresponds with red, negative b* corresponds with blue and positive b* corresponds with yellow. L* can be converted to reflectance with the following formula: L*=116(R/R₀)^{1/3}−16, where R is the reflectance and R₀ is a standard reflectance value.

U.S. Pat. Nos. 8,576,476 and 8,797,634 describe multicolor electrophoretic displays having a single back plane comprising independently addressable pixel electrodes and a common, light-transmissive front electrode. The common, light-transmissive front electrode is also known as the top electrode. A plurality of electrophoretic layers are disposed between the back plane and the front electrode. Displays described in these applications are capable of rendering any of the primary colors (red, green, blue, cyan, magenta, yellow, white and black) at any pixel location. However, there are disadvantages to the use of multiple electrophoretic layers located between a single set of addressing electrodes. The electric field experienced by the particles in a particular layer is lower than would be the case for a single electrophoretic layer addressed with the same voltage. In addition, optical losses in an electrophoretic layer closest to the viewing surface (for example, caused by light scattering or unwanted absorption) may affect the appearance of images formed in underlying electrophoretic layers.

Attempts have been made to provide full-color electrophoretic displays using a single electrophoretic layer. For example, U.S. Pat. No. 8,917,439 describes a color display comprising an electrophoretic fluid that comprises one or two types of pigment particles dispersed in a clear and colorless or colored solvent, the electrophoretic fluid being disposed between a common electrode and a plurality of pixel or driving electrodes. The driving electrodes are arranged to expose a background layer. U.S. Pat. No. 9,116,412 describes a method for driving a display cell filled with an electrophoretic fluid comprising two types of charged particles carrying opposite charge polarities and of two contrast colors. The two types of pigment particles are dispersed in a colored solvent or in a solvent with non-charged or slightly charged colored particles dispersed therein. The method comprises driving the display cell to display the color of the solvent or the color of the non-charged or slightly charged colored particles by applying a driving voltage that is about 1 to about 20% of the full driving voltage. U.S. Pat. Nos. 8,717,664 and 8,964,282 describe an electrophoretic fluid, and a method for driving an electrophoretic display. The fluid comprises first, second and third type of pigment particles, all of which are dispersed in a solvent or solvent mixture. The first and second types of pigment particles carry opposite charge polarities, and the third type of pigment particles has a charge level being less than about 50% of the charge level of the first or second type. The three types of pigment particles have different levels of threshold voltage, or different levels of mobility, or both.

Color electrophoretic displays typically have a short list of possible colors that can be made, called a palette. There are typically eight palette colors: blacK, Red, Green, Blue, Cyan, Magenta, Yellow, and White. A need exists for expanding the color palette of such displays.

### SUMMARY

A color display with an expanded color palette is disclosed. The display includes an electrophoretic display comprising a light-transmissive electrode at a display viewing surface, an array of pixel electrodes, and an electrophoretic medium disposed between the light-transmissive electrode and the pixel electrodes. The electrophoretic medium comprises multiple types of electrophoretic particles having different optical properties dispersed in a non-polar fluid. Each pixel electrode is associated with a display pixel. The electrophoretic display is capable of producing a plurality of primary colors and variations in hue, saturation, and/or luminance of the primary colors at each display pixel. The display also includes a display controller circuit configured to drive the display pixels to targeted color states by applying time-dependent voltages of waveforms between the pixel electrodes and the light-transmissive electrode. In addition, the display includes a non-transitory memory storing a set of primary color waveforms, each selectable by the display controller circuit for driving a selected display pixel to a corresponding primary color. The non-transitory memory also stores a set of scaling factors, each selectable by the display controller circuit to be applied to one of the primary color waveforms corresponding to a primary color to produce a scaled waveform for driving a selected display pixel to a targeted variation of the primary color.

A method of driving the color display is also disclosed. The method is performed by the display controller circuit, and includes the following steps: (a) receiving an image to be displayed on the electrophoretic display; and (b) driving each display pixel of the electrophoretic display to a targeted color state by applying time-dependent voltages of waveforms between the pixel electrodes and the light-transmissive electrode to render the image, wherein to produce a primary color at a display pixel, a primary color waveform corresponding to the primary color is selected from the set of primary color waveforms and applied to the display pixel, and wherein to produce a variation of a primary color at a display pixel, a scaling factor corresponding to the variation is selected from the set of scaling factors and applied to the corresponding primary color waveform to generate a scaled waveform, and the scaled waveform is applied to the display pixel.

In one or more embodiments, the non-transitory memory comprises one or more lookup tables mapping each of the primary color waveforms to a primary color produced thereby, and mapping each of the scaling factors to a variation of a primary color produced thereby.

In one or more embodiments, each scaling factor is a constant number.

In one or more embodiments, each scaling factor is greater than one or less than one.

In one or more embodiments, each scaling factor is greater than 1, but not greater than 1.1 or is less than 1, but not less than 0.9.

In one or more embodiments, the primary colors include one or more of blue, cyan, green, red, magenta, white, and yellow.

In one or more embodiments, the electrophoretic medium is encapsulated in microcapsules or microcups.

In one or more embodiments, the electrophoretic medium is bistable.

In one or more embodiments, the electrophoretic medium comprises at least four types of electrophoretic particles having different optical properties dispersed in the non-polar fluid.

In one or more embodiments, the color display comprises a dynamic color changing surface.

### BRIEF DESCRIPTION OF DRAWINGS

The patent or application file contains at least one drawing executed in color. Copies of this patent or patent application publication with color drawing(s) will be provided by the Office upon request and payment of the necessary fee.

FIG. 1 is a schematic cross-section showing an example of an encapsulated electrophoretic display suitable for use with the methods in accordance with various embodiments.

FIG. 2 is a schematic cross-section showing another example of an encapsulated electrophoretic display suitable for use with the methods in accordance with various embodiments.

FIG. 3 illustrates an exemplary equivalent circuit of a single pixel of an electrophoretic display wherein the voltage on the single pixel is controlled with a transistor. The circuit of FIG. 3 is commonly used in active matrix backplanes.

FIG. 4 is a block diagram illustrating an exemplary color display that includes a display module, which can be any electro-optic display module, but is preferably a color electrophoretic display module. The color display also includes a processor, memory, one or more power supplies, and a controller.

FIG. 5 is a schematic cross-section showing the positions of the various colored particles in a colored electrophoretic medium when displaying black, white, three subtractive primary colors and three additive primary colors.

FIG. 6 shows exemplary push-pull drive schemes for addressing an electrophoretic medium including three subtractive particles and a scattering (white) particle.

FIG. 7 is a flow chart illustrating an exemplary process for enhancing the color palette of an electrophoretic display in accordance with one aspect of the disclosure.

FIG. 8 is a chart illustrating one example of a set of scaling factors that can be applied to waveforms for a set of primary colors to produce variations of the primary colors.

FIG. 9 is chart illustrating another example of simulated primary colors compared to variations of the primary colors achieved by applying a set of scaling factors to the primary color waveforms.

FIG. 10 is a photograph showing an example of variations of a primary color produced on an electrophoretic display.

### DETAILED DESCRIPTION

Color electrophoretic displays typically have a limited set of palette colors: black, red, green, blue, cyan, magenta, yellow, and white. Various aspects of the invention relate to expanding the color palette of such displays.

An electrophoretic display device may be constructed using an electrophoretic fluid in several ways that are known in the prior art. The electrophoretic fluid may be encapsulated in microcapsules or incorporated into microcell structures that are thereafter sealed with a polymeric layer. The microcapsule or microcell layers may be coated or embossed onto a plastic substrate or film bearing a transparent coating of an electrically conductive material. This assembly may be laminated to a backplane bearing pixel electrodes using an electrically conductive adhesive. Alternatively, the electrophoretic fluid may be dispensed directly on a thin open-cell grid that has been arranged on a backplane including an active matrix of pixel electrodes. The filled grid can then be top-sealed with an integrated protective sheet/light-transmissive electrode.

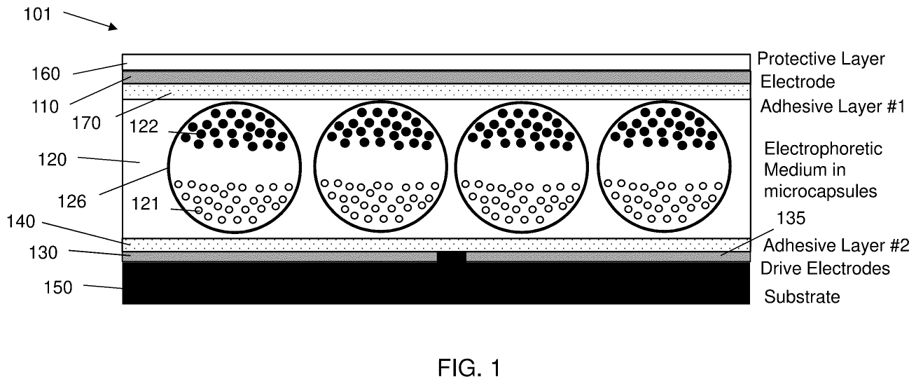

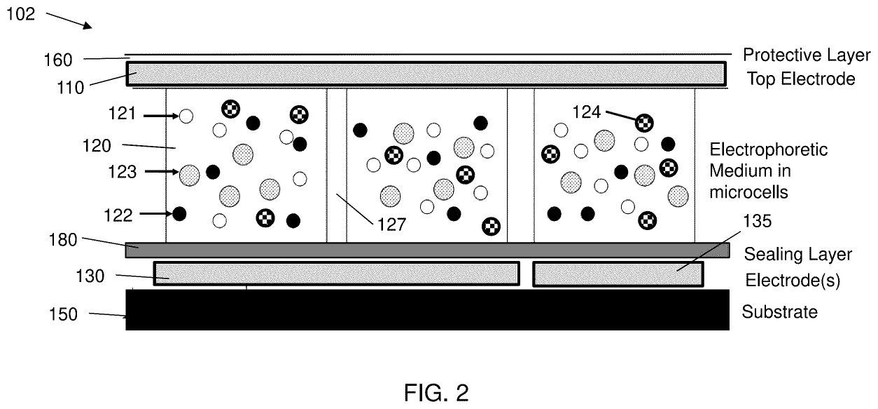

As shown in FIGS. 1 and 2, an electrophoretic display (101, 102) typically includes a top light-transmissive electrode 110, an electrophoretic medium 120, and bottom drive electrodes 130/135, which are often pixel electrodes of an active matrix of pixels controlled with thin film transistors (TFT). Alternatively, bottom drive electrodes 130/135 may be directly wired to a controller or some other switch that provides voltage to the bottom drive electrodes 130/135 to effect a change in the optical state of the electrophoretic medium 120, i.e., segmented electrodes. Importantly, it is not necessary that a junction between drive electrodes 130/135 corresponds with an intersection of microcapsules or with a wall 127 of a microcell. Because the electrophoretic medium 120 is sufficiently thin, and the capsules or microcells sufficiently wide, the pattern of the drive electrodes (square, circles, hexagons, wavy, text, or otherwise) will show when the display is viewed from the viewing surface; not the pattern of the containers. The electrophoretic medium 120 contains at least one electrophoretic particle 121, however a second electrophoretic particle 122, or a third electrophoretic particle 123, a fourth electrophoretic particle 124, or more particles is feasible. (It should be noted that third electrophoretic particles 123 and fourth electrophoretic particles 124 can be included within the microcapsules 126 of FIG. 1, but have been omitted for clarity.) The electrophoretic medium 120 typically includes a solvent, such as isoparaffins, and may also include dispersed polymers and charge control agents to facilitate state stability, e.g. bistability, i.e., the ability to maintain an electro-optic state without inputting any additional energy.

The electrophoretic medium 120 is typically compartmentalized by a microcapsule 126 or the walls of a microcell 127. The entire display stack is typically disposed on a substrate 150, which may be rigid or flexible. The display (101, 102) typically also includes a protective layer 160, which may simply protect the top electrode 110 from damage, or it may envelop the entire display (101, 102) to prevent ingress of water, etc. Electrophoretic displays (101, 102) may also include one or more adhesive layers 140, 170, and/or sealing layers 180 as needed. In some cases, an adhesive layer may include a primer component to improve adhesion to the electrode layer 110, or a separate primer layer (not shown in FIG. 1 or 2) may be used. (The structures of electrophoretic displays and the component parts, pigments, adhesives, electrode materials, etc., are described in many patents and patent applications published by E Ink Corporation, such as U.S. Pat. Nos. 6,922,276; 7,002,728; 7,072,095; 7,116,318; 7,715,088; and 7,839,564, all of which are incorporated by reference herein in their entireties.

Backplanes having TFTs usually have only one transistor per pixel electrode or propulsion electrode. Conventionally, each pixel electrode has associated therewith a capacitor electrode such that the pixel electrode and the capacitor electrode form a capacitor; see, e.g., International Patent Application WO 01/07961. In some embodiments, N-type semiconductor (e.g., amorphous silicon) may be used to form the transistors and the “select” and “non-select” voltages applied to the gate electrodes can be positive and negative, respectively.

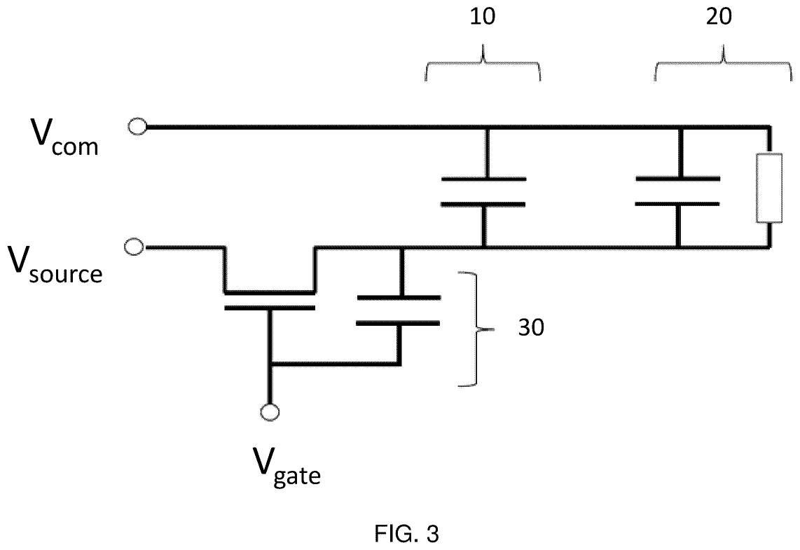

FIG. 3 depicts an exemplary equivalent circuit of a single pixel of an electrophoretic display. As illustrated, the circuit includes a capacitor 10 formed between a pixel electrode and a capacitor electrode. The electrophoretic medium 20 is represented as a capacitor and a resistor in parallel. In some instances, direct or indirect coupling capacitance 30 between the gate electrode of the transistor associated with the pixel and the pixel electrode (usually referred to a as a “parasitic capacitance”) may create unwanted noise to the display. Usually, the parasitic capacitance 30 is much smaller than that of the storage capacitor 10, and when the pixel rows of a display is being selected or deselected, the parasitic capacitance 30 may result in a small negative offset voltage to the pixel electrode, also known as a “kickback voltage”, which is usually less than 2 volts. To compensate for the unwanted kickback voltage, a common potential V_{com}, may be supplied to the top plane electrode and the capacitor electrode associated with each pixel, such that, when V_{com} is set to a value equal to the kickback voltage (V_{KB}), every voltage supplied to the display may be offset by the same amount, and no net DC-imbalance experienced.

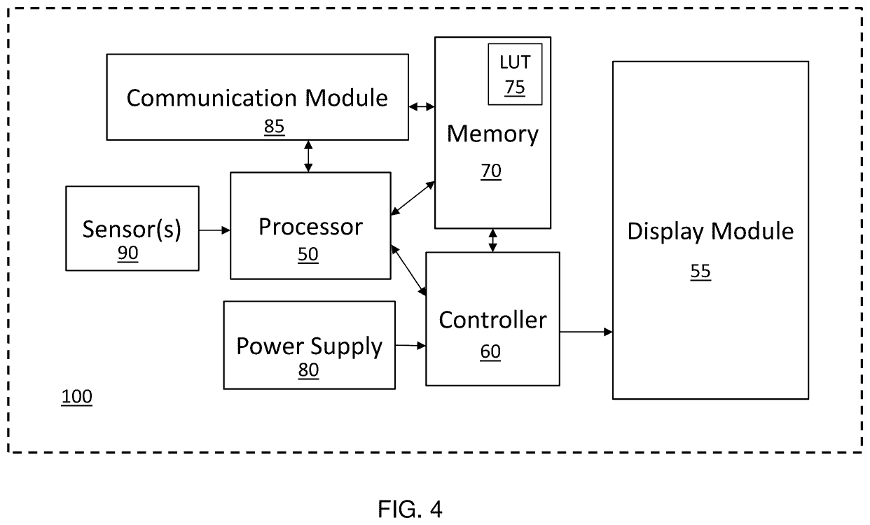

Typically, the TFTs are arranged in a matrix having gate and signal lines to each TFT, as well as a drain electrode typically coupled to a pixel electrode. This active matrix backplane is coupled to the electrophoretic medium, e.g., as illustrated in FIGS. 1 and 2, and typically sealed to create a display module 55, as shown in FIG. 4. Such a display module 55 becomes the focus of a color display 100. The color display 100 typically includes a processor 50, which is configured to coordinate the many functions relating to displaying content on the display module 55, and to transform “standard” images, such as sRGB images to a color regime that best duplicates the image on the display module 55. The processor is typically a mobile processor chip, such as made by Freescale or Qualcomm, although processors from other manufacturers can also be used. The processor is in frequent communication with the non-transitory memory 70, from which it pulls image files and/or color lookup tables to perform the color image transformations. The memory 70 may be flash memory. The color display 100 may have multiple non-transitory memory chips forming the memory 70. Once the desired image has been converted for display on the display module 55, the specific image instructions are sent to a display controller 60, which facilitates selection and transmission of waveform voltage sequences to the respective TFTs described above. Specifically, the display controller 60 consults a waveform lookup table (LUT) 75 to find the appropriate driving waveform to be applied for each pixel of the display based on the image data. The selected driving waveforms are then sent to the display module 55 to drive the display to the desired image. Such voltages typically originate from one or more power supplies 80, which may include, e.g., a power management integrated chip (PMIC). The color display 100 may additionally include a communication module 85, which may implement, e.g., WIFI or BLUETOOTH protocols, and allows the color display 100 to receive images and instructions, which also may be stored in memory 70. The color display 100 may additionally include one or more sensors 90, which may include a temperature sensor and/or a photo sensor, and such information can be fed to the processor 50 to allow the processor to select an optimum lookup-table entry when such lookup-tables are indexed for ambient temperature or incident illumination intensity or spectrum. In some instances, multiple components of the color display 100 can be embedded in a singular integrated circuit. For example, a specialized integrated circuit may fulfill the functions of the processor 50 and the display controller 60.

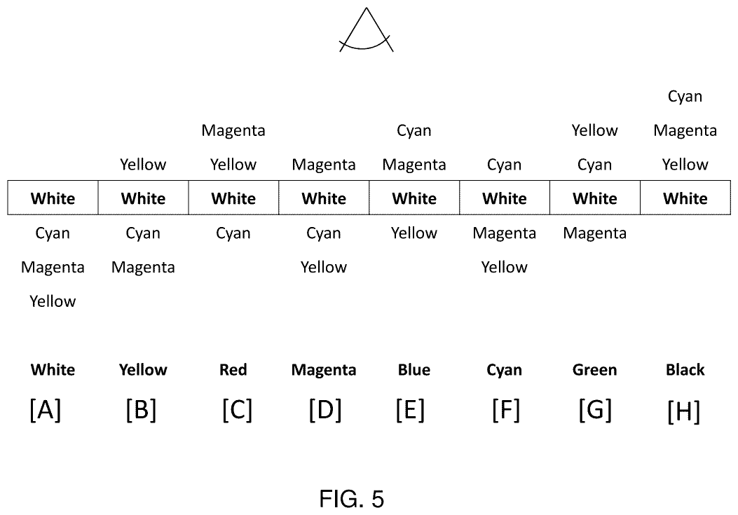

In the instance of ACeP®, each of the eight principal colors (red, green, blue, cyan magenta, yellow, black and white) corresponds to a different arrangement of the four pigments, such that the viewer only sees those colored pigments that are on the viewing side of the white pigment (i.e., the only pigment that scatters light). More specifically, when the cyan, magenta and yellow particles lie below the white particles (Situation [A] in FIG. 5), there are no particles above the white particles and the pixel simply displays a white color. When a single particle is above the white particles, the color of that single particle is displayed, yellow, magenta and cyan in Situations [B], [D], and [F] respectively in FIG. 5. When two particles lie above the white particles, the color displayed is a combination of those of these two particles; in FIG. 5, in Situation [C], magenta and yellow particles display a red color, in Situation [E], cyan and magenta particles display a blue color, and in Situation [G], yellow and cyan particles display a green color. Finally, when all three colored particles lie above the white particles (Situation [H] in FIG. 5), all the incoming light is absorbed by the three subtractive primary colored particles and the pixel displays a black color.

It is possible that one subtractive primary color could be rendered by a particle that scatters light, so that the display would comprise two types of light-scattering particles, one of which would be white and another colored. In this case, however, the position of the light-scattering colored particle with respect to the other colored particles overlying the white particle would be important. For example, in rendering the color black (when all three colored particles lie over the white particles), the scattering colored particle cannot lie over the non-scattering colored particles (otherwise they will be partially or completely hidden behind the scattering particle and the color rendered will be that of the scattering colored particle, not black). It would not be easy to render the color black if more than one type of colored particle scattered light.

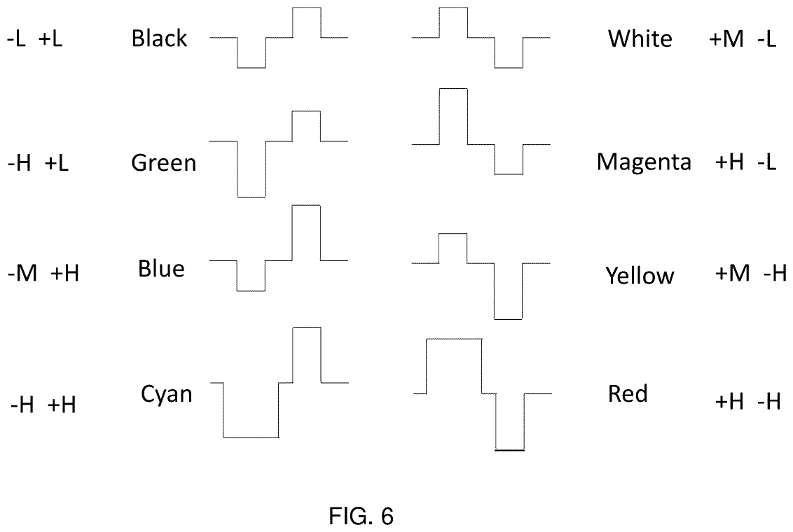

It has been found that waveforms to sort the four pigments into appropriate configurations to make these colors are best achieved with at least seven voltage levels (high positive, medium positive, low positive, zero, low negative, medium negative, high negative). FIG. 6 shows typical waveforms (in simplified form) used to drive a four-particle color electrophoretic display system described above. Such waveforms have a “push-pull” structure: i.e., they consist of a dipole comprising two pulses of opposite polarity. The magnitudes and lengths of these pulses determine the color obtained. In general, the higher the magnitude of the “high” voltages, the better the color gamut achieved by the display. The “high” voltage is typically between 20V and 30V, more typically around 25V, e.g., 24V. The “medium” (M) level is typically between 10V and 20V, more typically around 15V, e.g., 15V or 12V. The “low” (L) level is typically between 3V and 10V, more typically around 7V, e.g., 9V or 5V. Of course, the values for H, M, L will depend somewhat on the composition of the particles, as well as the environment of the electrophoretic medium. In some applications, H, M, L may be set by the cost of the components for producing and controlling these voltage levels.

As shown in FIG. 6, if the top electrode is held at a constant voltage (i.e., not top plane switched), even “simple” waveforms for the ACeP® system require that the driving electronics provide seven different voltages to the data lines during the update of a selected pixel of the display (+H, +M, +L, 0, −L, −M, −H). While multi-level source drivers capable of delivering seven different voltages are available, most commercially-available source drivers for electrophoretic displays permit only three different voltages to be delivered during a single frame (typically a positive voltage, zero, and a negative voltage).

Of course, achieving the desired color with the driving pulses of FIG. 6 is contingent on the particles starting the process from a known state, which is unlikely to be the last color displayed on the pixel. Accordingly, a series of reset pulses precede the driving pulses, which increases the amount of time required to update a pixel from a first color to a second color. The reset pulses are described in greater detail in U.S. Pat. No. 10,593,272, incorporated by reference herein. The lengths of these pulses (refresh and address) and of any rests (i.e., periods of zero voltage between them may be chosen so that the entire waveform (i.e., the integral of voltage with respect to time over the whole waveform) is DC balanced (i.e., the integral of voltage over time is substantially zero). DC balance can be achieved by adjusting the lengths of the pulses and rests in the reset phase so that the net impulse supplied in the reset phase is equal in magnitude and opposite in sign to the net impulse supplied in the address phase, during which phase the display is switched to a particular desired color.

While modifying the rail voltages provides some flexibility in achieving differing electro-optical performance from a four-particle electrophoretic system, there are many limitations introduced by top-plane switching. For example, it is typically preferred, in order to make a white state with displays of the present invention, that the lower negative voltage V_{M-}is less than half the maximum negative voltage V_{H-}.

An alternative solution to the complications of top-plane switching can be provided by fabricating the control transistors from less-common materials that have a higher electron mobility, thereby allowing the transistors to switch larger control voltages, e.g., +/−30V, directly. Newly-developed active matrix backplanes may include thin film transistors incorporating metal oxide materials, such as tungsten oxide, tin oxide, indium oxide, and zinc oxide. In these applications, a channel formation region is formed for each transistor using such metal oxide materials, allowing faster switching of higher voltages. Such transistors typically include a gate electrode, a gate-insulating film (typically SiO₂), a metal source electrode, a metal drain electrode, and a metal oxide semiconductor film over the gate-insulating film, at least partially overlapping the gate electrode, source electrode, and drain electrode. Such backplanes are available from manufacturers such as Sharp/Foxconn, LG, and BOE.

One preferred metal oxide material for such applications is indium gallium zinc oxide (IGZO). IGZO-TFT has 20-50 times the electron mobility of amorphous silicon. By using IGZO TFTs in an active matrix backplane, it is possible to provide voltages of greater than 30V via a suitable display driver. Furthermore, a source driver capable of supplying at least five, and preferably seven levels provides a different driving paradigm for a four-particle electrophoretic display system. In one example, there are two positive voltages, two negative voltages, and zero volts. In another example, there are three positive voltages, three negative voltages, and zero volts. In another example, there are four positive voltages, four negative voltages, and zero volts. These levels may be chosen within the range of about −27V to +27V, without the limitations imposed by top plane switching as described above.

Using advanced backplanes, such as metal oxide backplanes, it is possible to directly address each pixel with a suitable push-pull waveform, i.e., as described in FIG. 6. This greatly reduces the time required to update each pixel, in some instances, transforming a six-second update to less than one second. While, in some cases, it may be necessary to use reset pulses to establish a starting point for addressing, the reset can be done quicker at higher voltages. Additionally, in four-color electrophoretic displays having reduced color sets, it is possible to directly drive from a first color to a second color with a specific waveform that is only slightly longer than the push-pull waveforms shown in FIG. 6.

### Color Palette Enhancement

The present disclosure relates to expanding the color palettes of electrophoretic displays. The waveforms used in the electrophoretic displays for driving each display pixel to a target color state are typically finely tuned to produce specific colors. The tuning process is resource intensive and iterative, which limits the number of colors that can practically be made available. For matrix displays, spatial multiplexing can be used to achieve a wider gamut of colors. However, spatial multiplexing is not available for non-matrix displays.

Applicants have found that when a set of waveforms tuned to producing specific colors are modified by scaling their output voltage amplitudes, the hue, saturation, and luminance of the original produced colors are changed in a repeatable manner. As a result, within a specific range of scaling factors, a family of colors, centered on a target color, can be reliably reproduced, without the need to individually tune each color. A significant technical advantage of using such scaling factors is that the number of colors that can be produced using a given set of waveforms can be significantly increased, which provides greater design options for end users of color electrophoretic displays.

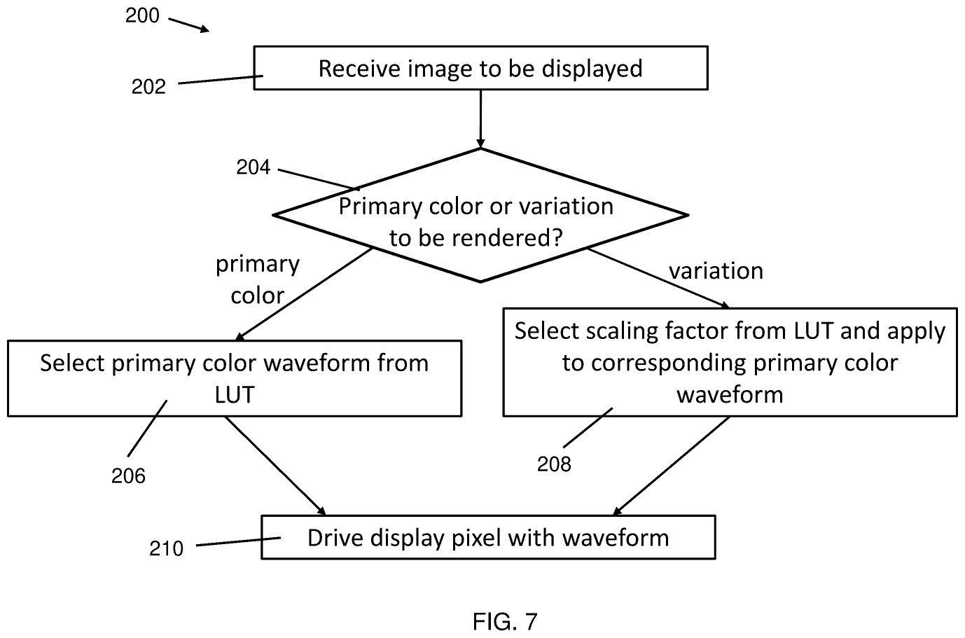

FIG. 7 is a flowchart illustrating an exemplary process 200 of expanding the color palette of an electrophoretic display in accordance with a first aspect of the invention. The electrophoretic display utilizes a set of waveforms for driving each display pixel to a given primary color. The electrophoretic display also stores a set of scaling factors that can be applied to each waveform to modify the voltage amplitudes of the waveforms to drive the display pixels to targeted variations of each primary color (e.g., variations in hue, saturation, and luminance).

At step 202, a controller in the display (e.g., display controller 60 shown in the electrophoretic display 100 of FIG. 4) receives an image to be displayed. This image may, e.g., be a standard sRGB image that has been transformed (e.g., by the display processor 50) to a format suitable for display on the electrophoretic device 100. The display controller 60 then determines and transmits suitable waveforms to the display module 55 to produce target colors at each display pixel to drive the display to the desired image. The process for driving each display pixel is as follows. At step 204, a determination is made as to whether a primary color or a variation (in hue, saturation, or luminance) of a primary color is to be produced at the display pixel. When the display pixel is to be driven to a primary color, at step 206, the controller consults a waveform lookup table (e.g., LUT 75) to find the driving waveform mapped to the desired primary color. When the display pixel is to be driven to a variation of a primary color, the controller consults the LUT 75 at step 208 to find the driving waveform mapped to the primary color and the scaling factor mapped to the desired variation of the primary color. The scaling factor is a constant number greater than one or less than one. The controller then multiplies the voltage amplitudes of the driving waveform by the scaling factor to generate a scaled driving waveform.

At step 210, the waveform selected in step 206 or modified by the scaling factor in step 208 is then sent to the display module 55 to drive the display pixel to the desired color.

The process is repeated for each of the display pixels such that the image received in step 202 is rendered on the display.

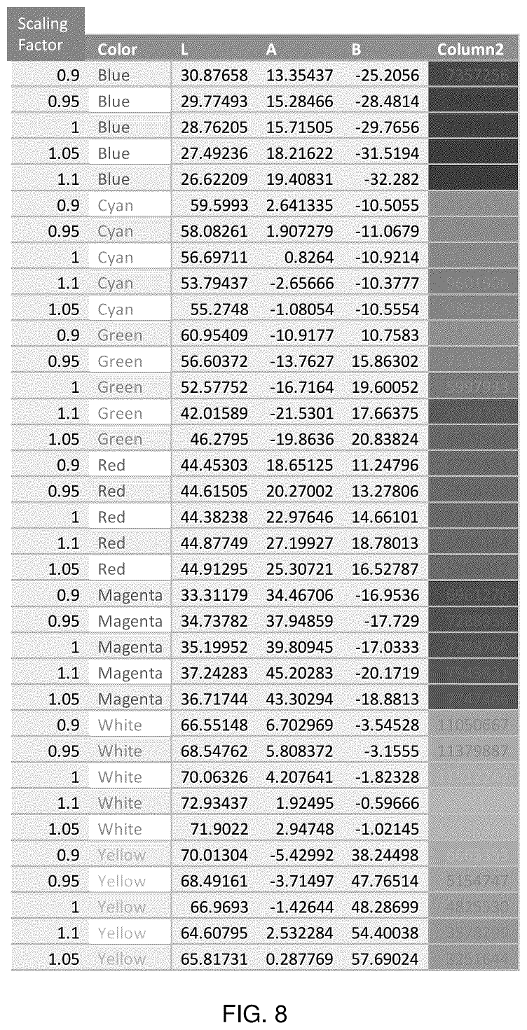

FIG. 8 is a chart illustrating one example of a set of scaling factors that can be applied to waveforms for a set of primary colors to produce variations of the primary colors. The chart provides a comparison of simulated primary colors and simulated variations of the primary colors, including by L*, a*, b* color properties.

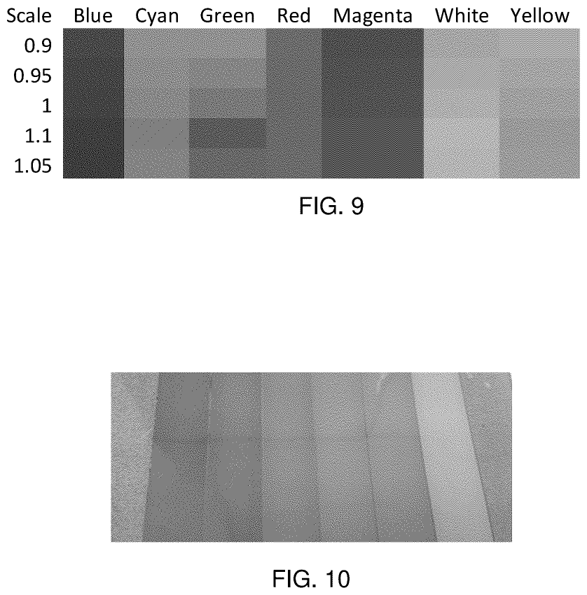

FIG. 9 is chart illustrating another example of simulated primary colors compared to variations of the primary colors achieved by applying a set of scaling factors to the primary color waveforms.

FIG. 10 is a photograph showing an example of variations of a primary color produced on an electrophoretic display based on the methods described above.

The process described above of producing an expanded color palette for electrophoretic displays can significantly increase the number of available colors. For example, FIGS. 8 and 9 show color palettes that have increased from 7 primary colors to 35 colors by the addition of four shades to each primary color. Expanded palettes of available colors are particularly beneficial to designers and product developers by increasing color options for a variety of electrophoretic display applications, including dynamic color changing surfaces (e.g., on external surfaces of vehicles and other products).

The process described above of producing an expanded color palette for electrophoretic displays is significantly less costly and time consuming than the conventional process of tuning a large number of waveforms to achieve the same palette.

In addition, the expanded color palette can be achieved without significantly increasing memory usage because waveforms are only stored in the memory for each primary color. Only scaling factors, which require significantly less memory usage, are stored for each variation of a primary color.

Furthermore, for matrix electrophoretic displays, the processes described above can be combined with image rendering to improve the smoothness of the final display output as dithered patterns are less visible, especially in image areas with subtle gradients.

The processes described above may be implemented in software, hardware, firmware, or any combination thereof. The processes are preferably implemented in one or more computer programs executing on the display controller. Each computer program can be a set of instructions (program code) in a code module resident in the random access memory of the controller. Until required by the controller, the set of instructions may be stored in another memory or stored on another computer system and downloaded via the Internet or other network.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. For example, those of ordinary skill in the art will readily envision a variety of other means and/or structures for performing the function and/or obtaining the results and/or one or more of the advantages described herein, and each of such variations and/or modifications is deemed to be within the scope of the embodiments described herein. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, kits, and/or methods described herein, if such features, systems, articles, materials, kits, and/or methods are not mutually inconsistent, is included within the scope of the present disclosure.

1. A color display with an expanded color palette, comprising:
an electrophoretic display comprising a light-transmissive electrode at a display viewing surface, an array of pixel electrodes, and an electrophoretic medium disposed between the light-transmissive electrode and the pixel electrodes, the electrophoretic medium comprising multiple types of electrophoretic particles having different optical properties dispersed in a non-polar fluid, wherein each pixel electrode is associated with a display pixel, and wherein the electrophoretic display is capable of producing a plurality of primary colors and variations in hue, saturation, and/or luminance of the primary colors at each display pixel;
a display controller circuit configured to drive the display pixels to targeted color states by applying time-dependent voltages of waveforms between the pixel electrodes and the light-transmissive electrode; and
a non-transitory memory storing a set of primary color waveforms, each selectable by the display controller circuit for driving a selected display pixel to a corresponding primary color, the non-transitory memory also storing a set of scaling factors, each selectable by the display controller circuit to be applied to one of the primary color waveforms corresponding to a primary color to produce a scaled waveform to drive a selected display pixel to a targeted variation of the primary color.

2. The color display of claim 1, wherein the non-transitory memory comprises one or more lookup tables mapping each of the primary color waveforms to a primary color produced thereby, and mapping each of the scaling factors to a variation of a primary color produced thereby.

3. The color display of claim 1, wherein each scaling factor is a constant number.

4. The color display of claim 1, wherein each scaling factor is greater than one or less than one.

5. The color display of claim 1, wherein each scaling factor is greater than 1, but not greater than 1.1 or is less than 1, but not less than 0.9.

6. The color display of claim 1, wherein the primary colors include one or more of blue, cyan, green, red, magenta, white, and yellow.

7. The color display of claim 1, wherein the electrophoretic medium is encapsulated in microcapsules or microcups.

8. The color display of claim 1, wherein the electrophoretic medium is bistable.

9. The color display of claim 1, wherein the electrophoretic medium comprises at least four types of electrophoretic particles having different optical properties dispersed in the non-polar fluid.

10. The color display of claim 1, wherein the color display comprises a dynamic color changing surface.

11. A method of driving a color display, wherein the color display comprises (i) an electrophoretic display comprising a light-transmissive electrode at a display viewing surface, an array of pixel electrodes, and an electrophoretic medium disposed between the light-transmissive electrode and the pixel electrodes, the electrophoretic medium comprising multiple types of electrophoretic particles having different optical properties dispersed in a non-polar fluid, wherein each pixel electrode is associated with a display pixel, and wherein the electrophoretic display is capable of producing a plurality of primary colors and variations in hue, saturation, and/or luminance of the primary colors at each display pixel; (ii) a display controller circuit; and (iii) a non-transitory memory storing a set of primary color waveforms for driving each display pixel to a corresponding primary color and for storing a set of scaling factors to be applied to one of the primary color waveforms to drive each display pixel to a targeted variation of the primary color, the method, performed by the display controller circuit, comprising:
(a) receiving an image to be displayed on the electrophoretic display; and
(b) driving each display pixel of the electrophoretic display to a targeted color state by applying time-dependent voltages of waveforms between the pixel electrodes and the light-transmissive electrode to render the image, wherein to produce a primary color at a display pixel, a primary color waveform corresponding to the primary color is selected from the set of primary color waveforms and applied to the display pixel, and wherein to produce a variation of a primary color at a display pixel, a scaling factor corresponding to the variation is selected from the set of scaling factors and applied to the corresponding primary color waveform to generate a scaled waveform, and the scaled waveform is applied to the display pixel.

12. The method of claim 11, wherein the non-transitory memory comprises one or more lookup tables mapping each of the primary color waveforms to a primary color produced thereby, and mapping each of the scaling factors to a variation of a primary color produced thereby.

13. The method of claim 11, wherein each scaling factor is a constant number.

14. The method of claim 11, wherein each scaling factor is greater than one or less than one.

15. The method of claim 11, wherein each scaling factor is greater than 1, but not greater than 1.1 or is less than 1, but not less than 0.9.

16. The method of claim 11, wherein the primary colors comprise one or more of blue, cyan, green, red, magenta, white, and yellow.

17. The method of claim 11, wherein the electrophoretic medium is encapsulated in microcapsules or microcups.

18. The method of claim 11, wherein the electrophoretic medium is bistable.

19. The method of claim 11, wherein the electrophoretic medium comprises at least four types of electrophoretic particles having different optical properties dispersed in the non-polar fluid.

20. The method of claim 11, wherein the color display comprises a dynamic color changing surface.
